(19) United States
(12) Patent Application Publication
(10) Pub. No.: US 2025/0128114 A1
(43) Pub. Date: Apr. 24, 2025

(54) COMPOSITIONS AND PROCESSES FOR REMEDIATING ENVIRONMENTAL CONTAMINANTS

(71) Applicants: Woodard & Curran, Portland, ME (US); BROWN UNIVERSITY, Rohde Island Nonprofit Corporation Formed And Existing Under Legislative Charter, Providence, RI (US)

(72) Inventors: James D. Bryant, Portland (ME); Lucas A. Hellerich, Portland (ME); Michael A. Apfelbaum, Portland, ME (US); Kurt Pennell, Providence, RI (US); Kate Manz, Providence, RI (US)

(73) Assignees: Woodard & Curran, Portland, ME (US); BROWN UNIVERSITY, A Rohde Island Nonprofit Corporation Formed And Existing Under Legislative Charter, Providence, RI (US)

(21) Appl. No.: 18/682,601

(22) PCT Filed: Aug. 10, 2022
(86) PCT No.: PCT/US2022/039943

§ 371 Date: Feb. 9, 2024

Related U.S. Application Data
(60) Provisional application No. 63/231,700, filed on Aug. 10, 2021.

(51) Int. Cl. A62D 3/38; A62D 3/33; A62D 101/22; B01J 20/02

(52) U.S. Cl. CPC A62D 3/38; A62D 3/33; B01J 20/02; A62D 2101/22; A62D 2203/02

(57) ABSTRACT

Compositions and process, along with systems using those compositions and processes are described herein for remediation of environmental contamination, including organic compound contamination of soil and ground water, including polyfluoroalkyl substances.

### TECHNICAL FIELD

The invention described herein pertains to remediation of environmental contamination, including organic compound contamination of soil and ground water. In addition, the invention described herein pertains to remediation of environmental contamination, including polyfluoroalkyl substances.

### BACKGROUND AND SUMMARY OF THE INVENTION

Soil and groundwater pollution is a serious problem that continues to affect the world's population and needs to be addressed. Organic contamination of soil and groundwater not only destroys the ecological environment itself, but directly or indirectly endangers the environment and human health and safety. The US Safe Drinking Water Act sets maximum contaminant levels for groundwater. Several states have also set additional limits. For example, limits exist for many volatile organic compounds (VOCs) and semi-volatile organic compounds, such as trichloroethylene, vinyl chloride, tetrachloroethylene, methylene chloride, 1,2-dichloroethane, 1,1,1-trichloroethane, carbon tetrachloride, chloroform, chlorobenzenes, benzene, toluene, xylene, ethyl benzene, ethylene dibromide, methyl tertiary butyl ether, 2,4-dimethylphenol, 2-methylphenol, and 3- and 4-methylphenol, polyaromatic hydrocarbons, polychlorobiphenyls, phthalates, 1,4-dioxane, nitrosodimethyl amine, and methyl tertbutyl ether. Effective remediation of groundwater has the objective of reducing such contamination to at least the maximum contaminant level set in the Safe Drinking Water Act and where applicable, the state maximum contamination level.

There are a variety of techniques that have been used to remediate groundwater, including injecting reagent chemicals or other substances into the groundwater in different locations to trap and/or decompose, eliminate, and/or neutralize the contaminants. The injected materials may react with the contaminants in the groundwater to eliminate them, to convert them into less harmful substances, and/or to otherwise neutralize them.

There are thousands of contaminated sites in the United States in need of remediation. Contamination at these sites, typically in groundwater and soil, results from past accidental or intentional releases of various materials, such as petroleum hydrocarbons, chlorinated solvents, pesticides, metals, and other industrially useful toxic chemicals, current or former military bases, gasoline stations, bulk fuel terminals, pipelines, dry cleaners, and other industrial manufacturing facilities.

Groundwater remediation processes generally fall into one of three categories: In-situ processes, ex situ processes, and removal. In-situ processes employ in-place treatment of contaminated soil and water. This process has the benefit of causing minimal disturbance to the site and can be at a lower cost than alternatives. Ex situ processes involve removing the water, using for example pump-and-treat technology, or removing the soil from the ground for treatment, then in each case returning the water and/or soil back into the site. Removal processes simply transport the contaminated soil or water for disposal at a hazardous waste facility. The removal site is then backfilled with clean materials. Ex situ and removal processes have high success rates; however, they also have high costs and a large carbon footprint.

In situ remediation processes are desirable for having lower costs, a lower carbon footprint, and less disturbance to sites and surrounding communities. However, depending upon the process used, the nature of the contaminated area, type of soil, and the nature of the contaminants, in-situ processes may have significantly more variable success rates. A wide variety of chemical and biological agents may be injected for remediation including reducing agents, oxidants, contaminant-degrading bacteria, sorbents, and compounds that stimulate bioremediation (biological electron donors and electron acceptors). One specific in-situ process is In-Situ Chemical Oxidation (ISCO) technology. ISCO processes generally include adding chemical oxidants to soil and groundwater to oxidize contaminants in groundwater to relatively less toxic products (for example, carbon dioxide, water, or chloride ions) for the purpose of remediation. Depending upon the nature of the contaminants, this type of technology can process multiple contaminants at the same time, and the treatment efficiency can be quite high because chemical oxidation is generally not limited by the concentration of contaminants. However, success rates of in situ treatments vary widely, and are lower than other processes due to the complexity of chemical contaminants that may be present. Some chemical contaminants are easily decomposed, whereas others are resistant and sometimes impossible to decompose.

One such class of compounds that are notoriously difficult to remediate are polyfluorinated compounds, and more specifically, compounds having at least one perfluoro —(CF₂)— or (CF₃)— group, and collectively referred to herein as “PFAS”. A subgroup of such compounds also includes a hydrophilic end group, such as a carboxylate, carboxamido, sulfonate, or sulfonylamido group, and the like. Such compounds, some of which are fluorosurfactants, have a hydrophobic carbon-fluorine containing chain and a polar or hydrophilic end group, and tend to be amphiphilic. It is to be understood that PFAS may also include compounds where one or more individual carbon atoms are not fully fluorinated, and instead include hydrogen, chlorine, bromine, or iodine, or a combination thereof. As used herein, the term “polyfluoroalkyl” refers to compounds having at least one carbon atom that is not fully fluorinated, and the term “perfluoroalkyl” refers to compounds where each carbon atom is fully fluorinated, i.e. where the alkyl portion has the formula (CF₃—CₙF₂ₙ).

Various PFAS are reportedly useful for extinguishing liquid-fuel fires. As such, these substances have found extensive use in mixtures of aqueous film-forming foams (AFFFs) as fire extinguishing agents. They are also found in many other industrial products, such as surfactants, mist suppressants, surface coatings, and the like, and in many commercial products, such as fabric coatings, papers, paints, cleaners, and the like.

Many varieties of PFAS have thus been released into the environment as part of firefighting and spill-response, both in actual emergencies and in fire-training activities by the military. These substances are very stable and quite soluble in water. PFAS are often referred to a “forever chemicals” because the perfluorocarbon moiety does not readily decompose under natural transformation reactions, such as biodegradation, photo-oxidation, photolysis, or hydrolysis. As a result, they are persistent in the environment and have the potential to travel long distances in aquifers. Both in vitro and in vivo studies, as well as epidemiologic studies, have linked PFAS exposure to a range of toxic effects to both humans and wildlife. Thus, their release into the environment, subsequent groundwater contamination, and persistence are of serious concern and PFAS have become the focus of regulatory interest.

Effective in-situ treatment of PFAS by oxidation, bioremediation, or other common in-situ technologies has not been demonstrated in large-scale site remediation, and therefore, ex situ remediation technology has been the primary process for treating PFAS groundwater contamination. Yet, such ex-situ pump and treat systems are expensive and energy intensive due to continuous pumping, trucking spent carbon offsite, and offsite incineration or landfill disposal. Moreover, the latter two steps institute a new risk of spreading contamination offsite, thus increasing liability. Additionally, such ex situ processes have a large carbon footprint owing to the large energy requirements to operate pumps to remove the water from the aquifer for treatment, for the further ex situ pyrolysis required to fully dispose of the material, and the high cost disposing of the secondary waste streams arising from decontamination.

It has been reported that persulfate anion (S₂O₈²⁻) can decompose perfluorooctanoic acid (PFOA) with external high-energy activation, such as with ultraviolet light, electrolysis, or high heat (>80° C.), and typically requiring a high pH (>10.5) or high concentrations of transition metal ions. Absent such activation, the persulfate anion has not been reported to decompose PFOA. Reports are mixed as to whether hydroxyl radicals, sulfate radicals, or both are formed with such high-energy activation of persulfate; however, such radicals do not form or do not form in sufficiently high concentrations at temperatures lower than about 40° C. Though persulfate can be activated solely by hydroxide ion, such activation alone (in the absence of a high-energy source, such as high heat) has not been reported to result in effective or consistent PFOA decomposition.

It is appreciated that it would be impractical to remediate environmental contamination using such high-energy activation due to the massive scale required for contamination sites, and the impracticality and expense of irradiating and or heating subsurface contamination, such as treatment zones in groundwater or aquifers, from ambient in-situ groundwater temperatures, not uncommonly less than 15° C., to the temperatures greater than 40° C. required for high-energy activation.

Additional compositions and processes are needed for use in remediating environmental sites, including complex environmental sites, such as for example, sites that are contaminated with PFAS.

It has been surprisingly discovered that the compositions and processes described herein are useful in remediating complex environmental contamination, including environmental sites contaminated with PFAS. It has also been surprisingly discovered herein that the compositions and processes described herein are useful in remediating complex environmental contamination contaminated with both PFAS and other organic compounds, such as dioxanes.

The compositions and processes described herein are useful for remediating sites contaminated with polyfluoro- and perfluoroalkylcarboxylic acids (PFCA), such as PFOA, and including ionized forms thereof, and polyfluoro- and perfluoroalkylsulfonic acids (PFSA), such as PFOS, and including ionized forms thereof. It has also been surprisingly discovered herein that PFCA, including PFOA, can be decomposed by activating persulfate, peroxides, and mixtures thereof, at low pH, including pH of about 3 or less, about 2 or less, or about 1. It has also been surprisingly discovered herein that PFCA, including PFOA, can be decomposed by activating persulfate at ambient temperature and at low (5-11° C.) ambient environmental temperatures representative of groundwater aquifers, without external heating. Illustrative activating agents include transition metal ions, such as reduced metal ions and electron rich ions. Illustrative activating agents include iron (II) compounds, such as but not limited to iron (II) sulfides (FeS, ferrous sulfide), pyrite, mackinawite, and iron (III) compounds, such as iron oxyhydroxide, goethite, and the like. Additional illustrative activating agents include powdered activated carbon (PAC). In addition, the persulfate may include pH modifying agents, such as hydroxide ion salts, including but not limited to potassium hydroxide, sodium hydroxide, and the like.

1,4-Dioxane is frequently used as a solvent in commercial products. Like PFAS, 1,4-dioxane is highly toxic and can cause liver damage, kidney failure, and cancer in humans and animals. 1,4-dioxane is very soluble and, like PFAS, also does not readily undergo natural transformation reactions, and can be found to create large groundwater contaminant plumes. Furthermore, 1,4-dioxane does not readily adsorb to carbon. Due to their recalcitrance to traditional groundwater remediation processes, PFOA and 1,4-dioxane are most commonly treated ex-situ by complex remediation systems that include sorption to activated carbon (for PFOA) and chemical oxidation (for 1,4-dioxane). PFAS are not susceptible to conventional ISCO, and instead must be adsorbed to carbon and treated ex situ. 1,4-Dioxane is susceptible to ISCO, but does not sorb to carbon, and therefore conventional methods for environmental contaminant remediation are not useful for cleaning this common co-contamination.

In complex environmental contamination sites, certain contaminants are not sufficiently susceptible to degradative process, such as persulfate or peroxide degradation. Similarly, in the those same complex environmental contamination sites, certain contaminants are not sufficiently susceptible to adsorption. Notably, a simple combination of those two processes is not generally possible. It has been discovered that the oxidative processes and the adsorption processes are not sufficiently compatible to allow them to be simply integrated into a single remediation stage. For example, the oxidizing components react with the adsorption components and render both aspects less effective or ineffective. In addition, a simple juxtaposition of those two processes is not generally possible. Following treatment in the oxidative processes, the groundwater effluent is generally too acidic for a subsequent adsorption process. For example, adsorbent carbon systems fail to trap many organic contaminants at low pH, such as pH lower than 3, or lower than 2.5.

However, it has been discovered herein, that complex environmental contamination can be remediated using a multi-stage system where the oxidation stage is separated from the adsorption stage by a predetermined distance sufficient to allow the two processes to cooperatively operate to mitigate complex mixtures, while not suffering interference from each other. The appropriate separation of the two stages can be determined by the flow characteristics of the soil and groundwater, and the contaminants therein. A pH adjusting third stage may also be incorporated between the first oxidative stage and second adsorptive stage to further promote cooperative operation of the first oxidation stage and the second adsorption stage. The pH adjustment is optionally combined with the adsorbent stage.

The compositions, processes, and systems described herein include activating persulfates, peroxides, or combinations thereof with an activating agent to degrade, decompose, and/or otherwise mitigate environmental contamination by certain contaminants. The compositions, processes, and systems described herein also include adsorbents for adsorbing certain contaminants in a second stage. The compositions, processes, and systems described herein also include pH modifying agents for modifying pH, such as between the first degradation stage and second adsorption stage.

In one illustrative embodiment of the invention described herein, a composition comprising a persulfate salt, a peroxide salt, or a combination thereof, and an activating agent, and configured for remediating an organic contaminant in the environment, such as in soil and/or groundwater is described.

In another illustrative embodiment of the invention described herein, a composition comprising a persulfate salt, a peroxide salt, or a combination thereof, and an iron compound, and configured for remediating an organic contaminant in the environment, such as in soil and/or groundwater is described.

In another illustrative embodiment of the invention described herein, a composition comprising a persulfate salt, a peroxide salt, or a combination thereof, and an iron (II) compound, and configured for remediating an organic contaminant in the environment, such as in soil and/or groundwater is described.

In another illustrative embodiment, a composition comprising a persulfate salt, a peroxide salt, or a combination thereof, and PAC is described herein, and configured for remediating an organic contaminant in the environment is described.

In another illustrative embodiment, processes, systems, and kits using the compositions described herein are also described.

In another embodiment, the compositions, processes, systems, and kits described herein are useful and effective in remediating environmental contamination comprising PFAS and additional contaminants, such as but not limited to chlorinated volatile organic compounds (cVOCs), 1,4-dioxane, and petroleum compounds such as naphthalene and benzene. Such suites of compounds are well-understood to pose a significant challenge for in-situ remediation because of the range of different chemical conditions required for treatment of cVOCs, petroleum hydrocarbons, and 1,4-dioxane.

In another embodiment, the compositions, processes, and systems described herein are useful and effective in remediating environmental contamination specifically comprising PFAS and 1,4-dioxane.

It has also been surprisingly found and demonstrated that processes using the compositions described herein, when coupled with additional treatment steps, are useful in treating a wider range of PFAS, including polyfluoro- and perfluoroalkylsulfonates and ionized forms thereof (PFSAs).

In another embodiment, described herein is a system comprising a two-stage in-situ reactive treatment zone. The first stage is comprised of chemical oxidant reagents, which destroy the cVOCs, petroleum hydrocarbons, 1,4-dioxane, and PFCAs as the contaminated groundwater migrates therethrough. The remaining PFSAs, and additional contaminants not destroyed in the first stage are removed from the groundwater by sorption in the second treatment stage, such as sorption to activated carbon. It is appreciated that some residual contaminants, such as cVOCs, that survive the first stage will nonetheless be adsorbed in the second stage. In addition, such surviving residual contaminants may be further degraded once adsorbed to the carbon due to microbial activity, whereas other contaminants may be trapped but not destroyed. It is appreciated that the systems described herein desirably remove sufficient contaminants from groundwater to meet cleanup standards set by the EPA and other governmental authorities after the groundwater passes through the second zone.

It has also been surprisingly found that in certain two-stage systems described herein, the groundwater leaving the first stage is at a low pH, and therefore, the adsorption efficiency at the second stage may be too low. In another embodiment, the second stage further comprises a buffer, such as calcium carbonate, to increase the pH, thereby increasing the adsorption efficiency of both metals and PFSAs. In another embodiment, the buffer may also be introduced to the aquifer as a third independent stage located between the first stage and the second stage. Illustratively, the pH is increased to about 1.5, about 2, about 2.5, or about 3 or greater.

In another illustrative embodiment, a process for remediating an organic contaminant in the environment/groundwater is described herein, where the process comprises introducing one or more of the compositions described herein into a reactive treatment zone containing soil or water, or both.

In another embodiment, a process is described herein for remediating an organic contaminant in the environment/groundwater is described herein, where the process comprises (a) introducing one or more of the compositions described herein into a reactive treatment zone containing soil or water, or both, and (b) introducing activated carbon into the reactive treatment zone, where the activated carbon is configured to adsorb one or more PFAS.

### BRIEF DESCRIPTION OF THE DRAWINGS

FIG. 1 shows activation of persulfate by PAC as function of persulfate concentration and temperature.

FIG. 2 shows the EPR spectrum of a radical adduct formed with spin trapping agent 140 mM DMPO in batch studies with 15 g/L PAC, 75 mM persulfate, and both 15 g/L PAC and 75 mM persulfate after 30 minutes.

FIG. 3 shows the formation of transformation products detected by non-targeted analysis. Peak Areas are normalized to the maximum peak area for each transformation product during PFOA degradation by 20 g/L PAC and 75 mM persulfate at room temperature. Error bars represent standard error (n=3).

FIG. 4 shows Decomposition of 1,4-dioxane and PFOA in 20 g/L PAC and 75 mM persulfate at 11° C. and ambient temperature (22° C.) over 8 and 6 hours, respectively. PFOA degraded into shorter chain PFCAs as shown in panels (a) and (d). In the 11° C. experiment, after adsorption for 72 hours, the initial PFOA concentration was 2240 nM, and impurities PFBA, PFPeA, PFHxA, and PFHpA were LOD, <LOD, 1.38, <LOD nM, respectively. In ambient temperature experiments, after adsorption for 72 hours, the initial PFOA concentration was 40 nM, and impurities PFBA, PFPeA, PFHxA, and PFHpA were LOD, 0.055, 0.033, 0.035 nM, respectively. Error bars represent standard error (n=3).

FIG. 5 shows an illustrative laboratory scale of the system described herein.

FIG. 6 shows an illustrative laboratory scale of the system described herein.

FIG. 7 shows the immobilization of metals during the first stage of buffering, as a function of pH.

FIG. 8 shows treatment of a sample groundwater containing PFAS and 1,4-dioxane after 35 pore volumes.

FIG. 9 shows treatment of a sample groundwater containing PFAS and 1,4-dioxane after 25 pore volumes.

### DETAILED DESCRIPTION

Several illustrative embodiments of the invention are described by the following clauses:

A composition configured for remediating an organic contaminant in the environment, such as in soil or groundwater, the composition comprising an oxidizing agent, such as a persulfate salt, a peroxide salt, or a combination thereof, and an activating agent.

The composition of the previous clause wherein the persulfate salt is potassium persulfate, sodium persulfate, ammonium persulfate, or a combination thereof.

The composition of any one of the preceding clauses wherein the persulfate salt is potassium persulfate.

The composition of any one of the previous clauses wherein the peroxide salt is an inorganic peroxide.

The composition of any one of the previous clauses wherein the peroxide salt is a solid inorganic peroxide.

The composition of any one of the previous clauses wherein the peroxide salt is calcium peroxide, magnesium peroxide, or a combination thereof.

The composition of any one of the preceding clauses wherein the activating agent comprises electron rich, or reduced, transition metal cations.

The composition of any one of the preceding clauses wherein the activating agent comprises transition metal cations selected from the group consisting of iron, manganese, chromium, zinc, silver, nickel, cobalt, and copper, and salts thereof, and combinations of the foregoing.

The composition of any one of the preceding clauses wherein the activating agent includes iron cations, such as iron (II) compounds.

The composition of any one of the preceding clauses wherein the activating agent includes an iron sulfide, such as pyrite, mackinawite, and the like.

The composition of any one of the preceding clauses wherein the activating agent includes iron (III) compounds, such as iron oxyhydroxide, goethite, and the like.

The composition of any one of the preceding clauses wherein the activating agent includes an iron sulfide.

The composition of any one of the preceding clauses wherein the activating agent comprises PAC.

The composition of any one of the preceding clauses substantially free of permanganate.

The composition of any one of the preceding clauses wherein the aggregate amount of the one or more activators is sufficient to produce hydroxyl radical (OH—⁻, E⁰=2.01V), sulfate radicals (SO₄—⁻, E⁰=2.7V), or combinations thereof, in-situ.

The composition of any one of the preceding clauses wherein the aggregate amount of the one or more activators is sufficient to promote direct electron transfer from persulfate to produce reactive oxygen species (ROS). It is understood that direct electron transfer from persulfate may produce ROS and other radicals more rapidly, in greater concentration, and with greater energy, such as E⁰>2.7, than ROS produced by hydroxyl and/or sulfate radicals. It is appreciated that the aggregate amount of the one or more activators will also be sufficient to produce hydroxyl radical (OH—⁻, E⁰=2.01V), sulfate radicals (SO₄—⁻, E⁰=2.7V) and combinations thereof, in-situ.

The composition of any one of the preceding clauses wherein the organic contaminant includes one or more polyfluoroalkyl substances.

The composition of any one of the preceding clauses wherein the organic contaminant includes one or more perfluoroalkyl substances.

The composition of any one of the preceding clauses wherein the organic contaminant includes one or more polyfluoroalkyl and one or more perfluoroalkyl substances.

The composition of any one of the preceding clauses wherein the PFAS include one or more polyfluorocarboxylates, one or more polyfluorosulfonates, or a combination thereof.

The composition of any one of the preceding clauses wherein the PFAS include one or more perfluorocarboxylates, one or more perfluorosulfonates, or a combination thereof.

The composition of any one of the preceding clauses wherein the PFAS include one or more polyfluorocarboxylates, one or more perfluorocarboxylates, one or more polyfluorosulfonates, one or more perfluorosulfonates, or a combination thereof.

The composition of any one of the preceding clauses wherein the PFAS include perfluorooctanoic acid and ionized forms thereof (PFOA), perfluorooctanesulfonic acid and ionized forms thereof (PFOS), or a combination thereof.

The composition of any one of the preceding clauses configured for remediating one or more contaminants selected from the group consisting of PFOA, PFHxA, PFHpA, PFPeA, and PFBA, and combinations thereof.

The composition of the preceding clause configured for remediating one or more contaminants selected from the group consisting of PFOA, PFHxA, PFHpA, PFPeA, and PFBA, and combinations thereof with co-contamination by a dioxane, such as 1,4-dioxane.

A process for remediating an organic contaminant in the environment, such as in the soil or groundwater, the process comprising (a) introducing the composition of any one of the preceding clauses into a reactive treatment zone containing the soil or water, or both.

The process of the preceding clause further comprising (b) introducing an adsorbing agent, such as activated carbon into the reactive treatment zone, where the adsorbing agent is configured to adsorb one or more PFAS.

The process of any one of the preceding clauses wherein the adsorbing agent, such as activated carbon includes a buffering agent capable of raising the pH.

The process of any one of the preceding clauses wherein the adsorbing agent, such as activated carbon includes a buffering agent, such as but not limited to calcium carbonate.

The process of any one of the preceding clauses wherein a buffering agent is introduced separately from the oxidizing agent and the adsorbing agent.

The process of any one of the preceding clauses wherein the composition is configured to remediate cVOCs, petroleum hydrocarbons, 1,4-dioxane, PFCAs, or a combination thereof.

The process of any one of the preceding clauses wherein the process is configured to provide treated water meeting one or more of the US or state-level drinking water or environmental cleanup standards, such as for example, standards set forth by the US EPA (https://www.epa.gov/sdwa/drinking-water-health-advisories-pfoa-and-pfos), including 0.004 parts per trillion (ppt) for PFOA, 0.02 ppt for PFOS, 10 ppt for GenX chemicals, and 2,000 ppt for PFBS; and in the State of New Jersey, which has promulgated standards of 13 nanograms per liter (ng/L) for PFOS, 14 ng/L for PFOA, and 13 ng/L for PFNA.

The process of any one of the preceding clauses wherein the process is configured for treating ground water in situ.

The process of any one of the preceding clauses wherein the treatment zone is an aquifer.

The process of any one of the preceding clauses wherein the organic contaminant includes one or more polyfluoroalkyl substances.

The process of any one of the preceding clauses wherein the organic contaminant includes one or more perfluoroalkyl substances.

The process of any one of the preceding clauses wherein the organic contaminant includes one or more polyfluoroalkyl and one or more perfluoroalkyl substances.

The process of any one of the preceding clauses wherein the PFAS include one or more polyfluorocarboxylates, one or more polyfluorosulfonates, or a combination thereof.

The process of any one of the preceding clauses wherein the PFAS include one or more perfluorocarboxylates, one or more perfluorosulfonates, or a combination thereof.

The process of any one of the preceding clauses wherein the PFAS include one or more polyfluorocarboxylates, one or more perfluorocarboxylates, one or more polyfluorosulfonates, one or more perfluorosulfonates, or a combination thereof.

The process of any one of the preceding clauses wherein the PFAS include perfluorooctanoic acid and ionized forms thereof (PFOA), perfluorooctanesulfonic acid and ionized forms thereof (PFOS), or a combination thereof.

The process of any one of the preceding clauses configured for remediating one or more contaminants selected from the group consisting of PFOA, PFHxA, PFHpA, PFPeA, and PFBA, and combinations thereof.

The process of the preceding clause configured for remediating one or more contaminants selected from the group consisting of PFOA, PFHxA, PFHpA, PFPeA, and PFBA, and combinations thereof with co-contamination by a dioxane, such as 1,4-dioxane.

The process of any one of the preceding clauses configured for treating water in-situ.

The process of any one of the preceding clauses configured for treating ground water at a temperature of about 55° C. or less, about 50° C. or less, about 45° C. or less, about 40° C. or less, about 35° C. or less, about 30° C. or less, about 25° C. or less, about 20° C. or less, about 15° C. or less, or about 10° C. or less.

The process of any one of the preceding clauses configured for treating ground water at ambient temperature.

The process of any one of the preceding clauses configured for treating ground water at a temperature in the range from about 55° C. to about 5° C., about 50° C. to about 5° C., about 45° C. to about 5° C., about 40° C. to about 5° C., about 35° C. to about 5° C., about 30° C. to about 5° C., about 25° C. to about 5° C., about 20° C. to about 5° C., about 15° C. to about 5° C., or about 10° C. to about 5° C.

The process of any one of the preceding clauses configured for treating ground water at a temperature in the range from about 55° C. to about 10° C., about 50° C. to about 10° C., about 45° C. to about 10° C., about 40° C. to about 10° C., about 35° C. to about 10° C., about 30° C. to about 10° C., about 25° C. to about 10° C., about 20° C. to about 10° C., or about 15° C. to about 10° C.

The process of any one of the preceding clauses configured for treating ground water without external heating.

The process of any one of the preceding clauses configured for treating ground water without added transition metal.

A kit comprising a predetermined quantity of any one of the compositions of any one of the preceding clauses; and instructions for co-introduction of the kit components into the treatment zone.

A packaged article comprising a predetermined quantity of any one of the compositions of any one of the preceding clauses; and instructions for co-introduction of the kit components into the treatment zone.

A system for remediating a contaminant in the environment, the system comprising:
(a) a first stage adapted to decompose at least a portion of the contaminant, the first stage comprising a process comprising (1) providing an oxidant comprising one or more persulfate salts, including potassium persulfate, sodium persulfate, ammonium persulfate, or one or more peroxide salts, or any combination thereof; (2) activating the oxidant with an activating agent; and (3) contacting the contaminant with the activated oxidant whereby at least a portion of the contaminant is decomposed;
(b) a two-part second stage adapted to adsorb at least a portion of the contaminant, the second stage comprising a process comprising contacting the contaminant with (1) a buffering compound adapted to increase the pH of at least a portion of the environment containing the contaminant; and (2) an adsorbent comprising activated carbon, such as granular activated carbon, powder activated carbon, and colloidal or liquid activated carbon, or combinations thereof, whereby at least a portion of the contaminant is absorbed or adsorbed;
wherein the first stage is separated from the second stage; and
wherein the buffering compound is included in a third stage between the first and second stages, or optionally combined with the adsorbent in the second stage.

The system of the preceding clause wherein the buffering compound is included in a third stage between the first and second stages.

The system of the preceding clause wherein the second and third stages are combined and the buffering compound is incorporated into the second stage with the adsorbent.

The system of any one of the preceding clauses wherein the second stage is separated from the first stage by a distance sufficient to substantially decrease the reactive potential of the oxidants in the first stage to a level compatible with the second stage. It is appreciated herein that the distance can be based on and/or dependent upon the groundwater flow and the nature of both the oxidizing agent and the adsorbent.

The system of any one of the preceding clauses wherein the second stage is separated from the first stage by a distance sufficient to allow an intervening pH adjustment step or stage to increase the pH of the soil and/or groundwater to a level compatible with the second stage. It is appreciated herein that the distance can be based on and/or dependent upon the groundwater flow. It is understood that low pH may degrade the adsorbent, and/or decrease its adsorptive properties.

The system of the preceding clause wherein the second stage is separated from the first stage by a distance of at least about 5 feet.

The system of the preceding clause wherein the second stage is separated from the first stage by a distance of at least about 10 feet.

The system of the preceding clause wherein the second stage is separated from the first stage by a distance of at least about 20 feet.

The system of any one of the preceding clauses wherein the oxidant is a persulfate salt.

The system of any one of the preceding clauses wherein the oxidant is a solid inorganic peroxide.

The system of any one of the preceding clauses wherein the process in the first stage comprises activating the persulfate with a reduced transition metal ion.

The system of any one of the preceding clauses wherein the transition metal is selected from the group consisting of iron, manganese, chromium, zinc, silver, nickel, cobalt, copper, and salts thereof, and combinations of the foregoing.

The system of any one of the preceding clauses wherein the transition metal salt is an iron sulfide, such as a pyrite.

The system of any one of the preceding clauses wherein the transition metal salt has any combination of one or more of the transition metals selected from iron, manganese, zinc, nickel, cobalt, silver, and copper.

The system of any one of the preceding clauses wherein the contaminant comprises one or more organic compounds selected from the group consisting of a dioxane, volatile organic compounds, and heavy metals.

The system of any one of the preceding clauses wherein the contaminant comprises perfluoroalkyl and polyfluoroalkyl substances (PFAS).

The system of any one of the preceding clauses wherein the contaminant comprises one or more polyfluoroalkanoic acids or salts thereof, perfluoroalkanoic acids or salts thereof, or a combination of the foregoing.

The system of any one of the preceding clauses wherein the PFAS comprises one or more of the group consisting of perfluorooctanoic acid or perfluorooctanoate (collectively, PFOA), and perfluorooctane sulfonic acid or perfluorooctane sulfonate (collectively, PFOS).

The system of any one of the preceding clauses wherein the organic contaminant includes one or more polyfluoroalkyl substances.

The system of any one of the preceding clauses wherein the organic contaminant includes one or more perfluoroalkyl substances.

The system of any one of the preceding clauses wherein the organic contaminant includes one or more polyfluoroalkyl and one or more perfluoroalkyl substances.

The system of any one of the preceding clauses wherein the PFAS include one or more polyfluorocarboxylates, one or more polyfluorosulfonates, or a combination thereof.

The system of any one of the preceding clauses wherein the PFAS include one or more perfluorocarboxylates, one or more perfluorosulfonates, or a combination thereof.

The system of any one of the preceding clauses wherein the PFAS include one or more polyfluorocarboxylates, one or more perfluorocarboxylates, one or more polyfluorosulfonates, one or more perfluorosulfonates, or a combination thereof.

The system of any one of the preceding clauses wherein the PFAS include perfluorooctanoic acid and ionized forms thereof (PFOA), perfluorooctanesulfonic acid and ionized forms thereof (PFOS), or a combination thereof.

The system of any one of the preceding clauses configured for remediating one or more contaminants selected from the group consisting of PFOA, PFHxA, PFHpA, PFPeA, and PFBA, and combinations thereof.

The system of the preceding clause configured for remediating one or more contaminants selected from the group consisting of PFOA, PFHxA, PFHpA, PFPeA, and PFBA, and combinations thereof with co-contamination by a dioxane, such as 1,4-dioxane.

The system of any one of the preceding clauses wherein the process in the first stage is adapted for decreasing the PFAS concentration by about 50% or more.

The system of any one of the preceding clauses wherein the process in the first stage is adapted for decreasing the PFAS concentration by about 90% or more.

The system of any one of the preceding clauses wherein the process in the first stage is adapted for decreasing the PFAS concentration to about 50 nanograms per liter or less.

The system of any one of the preceding clauses wherein the absorbent is activated carbon.

The system of any one of the preceding clauses wherein the buffering compound is present in an amount sufficient to raise the pH of the portion of the environment containing the contaminant to about 5 or greater.

The system of any one of the preceding clauses wherein the buffering compound is selected from the group consisting of calcium carbonate, calcium hydroxide, magnesium carbonate, magnesium hydroxide, calcium-magnesium carbonate, calcium-magnesium hydroxide and combinations thereof.

The system of any one of the preceding clauses wherein the PFAS comprises PFOS.

The system of any one of the preceding clauses wherein the process in the second stage is adapted for decreasing the PFOS concentration by about 50% or more.

The system of any one of the preceding clauses wherein the process in the second stage is adapted for decreasing the PFOS concentration by about 90% or more.

The system of any one of the preceding clauses wherein the process in the second stage is adapted for decreasing the PFOS concentration to about 50 nanograms per liter or less.

The system of any one of the preceding clauses including one or more permeable reactive barriers (PRBs).

The system of any one of the preceding clauses including a funnel and gate configuration.

The activation of persulfate, such as with high heat, may result in the formation of the reactive oxygen species (ROS); however, reports are conflicting as to whether persulfate activation produces ROS via radical mechanisms. See Lee et al., “Promoted degradation of perfluorooctanic acid by persulfate when adding activated carbon” J Hazardous Materials 261:463-469 (2013); Yao et al., “Insights into the mechanism of non-radical activation of persulfate via activated carbon for the degradation of p-chloroaniline” Chemical Eng J 362:262-268 (2019). In addition, reported studies using electron paramagnetic resonance (EPR) spectroscopy measurements of spin trapping reagents have not identified radical-derived ROS.

Without being bound by theory, it is believed herein that sulfate radicals and hydroxyl radicals may react with one or more environmental contaminants, resulting in remediation. For example, activation of persulfate with heat generates sulfate and hydroxyl radicals that are useful in decomposing or destroying certain environmental contaminants. However, it has been observed that sulfate and hydroxyl radicals are slow to react with certain other environment contaminants, such as PFAS. It has been unexpectedly discovered, however, that persulfate activated with PAC generates higher energy reactive oxygen species (ROS) than certain other processes of activating persulfate. Without being bound by theory, it is believed herein that activation of persulfate with PAC generates higher energy peroxyl radicals, and it is those higher energy peroxyl radicals that lead to faster and more complete reaction with PFAS, and/or faster and more complete reaction with PFAS at lower temperatures, including ambient temperatures that may be as low as 5° C.

In each of the foregoing and each of the following embodiments, unless otherwise indicated, it is also to be understood that the transitional phrase “consisting essentially of” means that the scope of the corresponding composition, unit dose, process or use is understood to encompass the specified compounds or recited steps, and those that do not materially affect the basic and novel characteristics of the invention described herein.

As used herein, the term “introduction” generally refers to injection, placement, or deposition, of a composition into the contaminated environment that is to be remediated. That environment may be a surface water, groundwater, aquifer, and the like.

As used herein, the term “remediation” generally refers to the decrease in level of one or more unwanted or undesirable compounds present in the environment, such as soil contamination, surface water contamination, and/or ground water contamination.

As used herein, the term “degradation” generally refers to the conversion of one or more unwanted or undesirable compounds present in the environment, such as soil contamination, surface water contamination, and/or ground water contamination into a compound that is less unwanted or less undesirable, such as a compound that is less toxic, or more easily remediated by a companion composition or process, and the like.

As used herein, the term “about” when used with numerical values or limits generally means that the number is approximate and that, as recited, it is understood to include a range of values. For example, a real number that is recited with a single significant figure, would by definition include a so-called rounding range; the number about 5 would at the very least include the range 4.5-5.4, as each of those values rounds to 5. The same is to be understood for real numbers expressed with additional significant figures, where the corresponding rounding range applies to the last significant figure. Integers are to be understood to at least include the values ±1 for single-digit numbers, ±10 for two-digit numbers, etc. Depending upon the context and the variable recited, the term “about” is also interpreted to contemplate a range based on a percentage of the recited number, such as about 5 construed to include 5±10% or 5±20%. Notwithstanding the foregoing, it is understood that the range of values, unless otherwise indicated, should not be interpreted to include a negative range for a positively recited number, and vice-versa. In addition, depending up on the context, the recited number, unless otherwise indicated, should not be interpreted to include a value of zero when used in conjunction with an added component.

Permeable reactive barriers (PRBs) can be formed either by a trench or a series of chemical injections. These PRBs are vertical treatment zones installed perpendicular to groundwater flow and are intended to stay in place for extended periods of time (months to years) and treat the moving groundwater as it flows through. This approach helps prevent expansion of contaminated areas and isolates sources of contamination until they can be addressed directly. Positional stability of the remediation chemicals is an important feature of a PRB. Illustratively, one or more PRBs are place in the groundwater flow. For example, pPersulfate or peroxide and an activating agent as described herein are injected upstream of the barrier and flow with the contaminant to be remediated to and through the PRB.

As used herein, the term “PFAS” generally refers to one or more polyfluoroalkyl or perfluoroalkyl substances, or a combination thereof, where at least one carbon atom is a perfluorinated aliphatic carbon atom. It is to be understood that PFAS include compounds that have a (CF₃)— and/or —(CF₂)— group or an extended alkyl chain of the formula CₙF₍₂ₙ₊₁₎ or CₙF₂ₙ.

It is to be understood that in every instance disclosed herein, the recitation of a range of integers for any variable describes the recited range, every individual member in the range, and every possible subrange for that variable. For example, the recitation that n is an integer from 0 to 8, describes that range, the individual and selectable values of 0, 1, 2, 3, 4, 5, 6, 7, and 8, such as n is 0, or n is 1, or n is 2, etc. In addition, the recitation that n is an integer from 0 to 8 also describes each and every subrange, each of which may for the basis of a further embodiment, such as n is an integer from 1 to 8, from 1 to 7, from 1 to 6, from 2 to 8, from 2 to 7, from 1 to 3, from 2 to 4, etc.

As used herein, the term “composition” generally refers to any product comprising the specified ingredients in the specified amounts, as well as any product which results, directly or indirectly, from combinations of the specified ingredients in the specified amounts. It is to be understood that the compositions described herein may be prepared from isolated compounds described herein or from salts, solutions, hydrates, solvates, and other forms of the compounds described herein.

The following examples further illustrate specific embodiments of the invention; however, the following illustrative examples should not be interpreted in any way to limit the invention. Unless otherwise indicated, all starting compounds, reagents, and solvents used in the following examples are available from commercial suppliers.

### Examples

EXAMPLE. Reagents. Total Ionic Strength Adjustment Buffer (TISAB), 10 ppm fluoride with TISAB standard, and anhydrous potassium persulfate, sodium bicarbonate, magnesium sulfate, sodium chloride, and calcium chloride, Fisher Scientific (Waltham, MA, USA); potassium iodide (99%) and potassium chloride, Alpha Aesar and Macron Fine chemicals, respectively; Darco® PAC at 100 mesh particle size, Sigma Millipore (Burlington, MA, USA); 1,4-dioxane (99.8% extra dry) and perfluorooctanoic acid (PFOA) (96%), Acros Organics and Sigma Millipore, respectively; 5,5-Dimethyl-1-pyrroline N-Oxide (DMPO, 97.0+%), TCI Chemicals (Portland, OR, USA); Ammonium acetate solution (5 M, LC-MS grade), Sigma-Aldrich (St. Louis, MO, USA); Ultrapure water (UHPLC-M grade) and methanol (LC-MS grade), Thermo Fisher Scientific (Waltham, MA, USA), isotopically labeled PFAS internal standards (perfluoro-n-(¹³C₄) butanoic acid, perfluoro-n-(¹³C₅) pentanoic acid, perfluoro-n-(1,2,3,4,6-¹³C₅) hexanoic acid, perfluoro-n-(1,2,3,4-¹³C₄) heptanoic acid, and perfluoro-n-(¹³C₈)octanoic acid), Wellington Laboratories (Overland Park, KS, USA).

All solutions were prepared using ultrapure water purified by a Millipore Milli-Q® Reference purification system (18.2 MΩ·cm at 25° C. and total organic content below 5 ppb).

Mass spectrometry analysis showed that the PFOA contained perflurocarboxylc acid (PFCA) impurities, including perfluorobutanoic acid (PFBA) (0.04 wt. %), perfluoropentanoic acid (PFPeA) (0.17 wt. %), perfluorohexanoic acid (PFHxA) (3.64 wt. %), and perfluoroheptanoic acid (PFHpA) (13.8 wt. %). Certified reference standards were used for quantitation of 1,4-dioxane (purity >97%) and perfluoro carboxylic acids (PFCAs) and were purchased from Accustandard (New Haven, CT, USA) and Wellington Laboratories (Overland Park, KS, USA), respectively.

EXAMPLE. Persulfate anion measurements. The persulfate anion concentration is measured spectrophotometrically using conventional methods. Liang et al., A rapid spectrophotometric determination of persulfate anion in ISCO. Chemosphere 73(9):1540-1543 (2008). Briefly, 5 mL aliquot of a solution containing 166 g L⁻¹ potassium iodide and 12 g L⁻¹ sodium bicarbonate in ultrapure water is added to a 4-dram amber glass vial. A 10 μL volume of sample is added to the KI/NaHCO₃ aliquot and reacted for 20 minutes. The optical density of the mixture is measured at the maximum wavelength, □ₘₐₓ, of 352 nm on a UV/Vis spectrophotometer (V-730, JASCO, Easton, MD). An eight-point standard calibration curve is prepared by the addition of a stock solution of potassium persulfate solution into 5 mL aliquots of KI/NaHCO₃.

EXAMPLE. 1,4-Dioxane measurements. 1,4-dioxane concentrations are measured using headspace analysis based on high-resolution Thermo Q Exactive Orbitrap MS equipped with a Thermo Trace 1300 GC and a TriPlus RSH Autosampler. The GC-headspace vials containing experimental water sample, 400 μL methanol, and 2 g sodium chloride are incubated at 90° C. for 60 minutes. A 2.5 mL volume of the gas phase is sampled and injected into a split-splitless inlet at 290° C. Sample components are separated on a Rtx-35 column with helium (99.9999% purity) as the carrier gas at 1 mL/min. The GC oven is programmed as follows: 45° C. for 3 minutes, increase to 220° C. at 60° C./min, and hold at 220° C. 1.25 minutes. The total run time is 7 minutes and data are collected between 2 and 6 minutes. The 1,4-dioxane elutes from the column at 3.08 minutes. The MS is operated in electron ionization (EI) mode (70 eV) and the data are collected in full scan mode with a mass range of 40 to 90 m/z, 60,000 resolution, and automatic gain control (AGC) of 1×10⁶. The 88.0519 m/z ion peak is used for quantification as it is typically the most abundant peak in the mass spectrum and the 87.0441 and 43.0178 m/z peaks are used as confirming ions. Quantification is performed using eight-point calibration curve prepared by serial dilution of calibration standards in 5 mL ultrapure water (1 to 50 μg L⁻¹). The limit of detection (LOD) of 3 μg L⁻¹ is determined by injecting seven calibration standards, and calculated as LOD=((t*s)/m) where t is the student's t value for a 99% confidence level with n−1 degrees freedom (t=3.14), s is the standard deviation of the mean, and m is the slope of the calibration curve.^{40,41}

EXAMPLE. PFCA measurements. PFCAs are measured using Waters H-class ACQUITY UPLC® with a Waters Xevo™ TQ-S Micro triple quadrupole mass spectrometer (LC-MS/MS). The LC-MS/MS is fitted with a PFAS analysis modification kit to minimize the risk of contamination. A 10 μL volume of each sample is injected in the LC-MS/MS instrument and the compounds are separated using a C18 column (ACQUITY UPLC BEH C18, 2.1 mm×50 mm, 1.7 μm) held at 50° C. The mobile phase A consisted of 2 mM ammonium acetate in 5% methanol and the mobile phase B consisted of 2 mM ammonium acetate in 100% methanol. The separation of analytes is achieved at a flow rate of 0.4 mL/min using the following solvent gradient program: 10% B for 1.2 min, increase to 85% B in 17 minutes, increase to 100% B for 0.5 minutes, and decrease over 0.5 minutes to the initial conditions for equilibration. The total run time is 20 minutes. The acquisitions are performed in negative ion electrospray mode with multiple reaction monitoring (MRM) and the monitoring is performed using two precursor-to-product ion transitions for all analytes, which are listed in Table S1. The source and fragmentation settings are optimized for each analyte and internal standard and eight-point calibration curves are used to quantify the PFCAs. The LODs range between 4.12-7.01 ng L⁻¹, as follows: Perfluorobutanoic acid (PFBA) 6.54; Perfluoropentanoic acid (PFPeA), 5.37; Perfluorohexanoic acid (PFHxA), 7.01; Perfluoroheptanoic acid (PFHpA), 5.75; Perfluorooctanoic acid (PFOA), 4.12.

EXAMPLE. Mobile Phase Gradient for Non-targeted Analysis. A solvent gradient consisting of mobile phases A (2 mM ammonium acetate in 5% methanol) and B (2 mM 5 ammonium acetate in 100% methanol) at a constant flow rate of 0.4 mL/min is used to separate sample components. The solvent gradient is: equilibration with 10% B from 0 to 1 minute, gradient ramp from 10% B to 100% B from 1 to 5 minutes, 100% B from 5 to 8 minutes, 100% to 10% from 8 to 9 minutes, and hold at 10% B until 11 minutes (total run time 11 minutes, data collected from 0.6 to 9 minutes).

EXAMPLE. Characterization of Spent PAC and PAC powder. The spent PAC is recovered after reacting 15 g of PAC with 75 mM potassium persulfate for 24 hours using vacuum filtration with Grade 42 Whatman filter paper on a Buchner funnel. Subsequently, spent PAC is compared to fresh PAC, which had not been exposed to persulfate. A Jasco FTIR 4100 instrument with a total reflectance ATR accessory is used to investigate oxygen-derived functional groups in the sample. A Thermo Fisher Scientific K-Alpha X-ray Photoelectron Spectrometer (XPS) is used to obtain the XPS spectrum, which displays a plot of the number of electrons detected at a specific binding energy for both samples. An Anton-Paar Autosorb-1 instrument is used to obtain N₂ vapor isotherms at 77 K. The surface areas based on Brunauer-Emmett-Teller (BET) theory and pore size distributions (PSD) based on the non-local density functional theory (NLDFT) slit pore model are calculated from N₂ vapor isotherms. Thermogravimetric analysis is used to quantify the mass loss when samples are heated from room temperature to 950° C. with a heating rate of 10 K/min in inert gas flow (100 mL/min N₂) using a thermal gravimetric analysis coupled with differential scanning calorimetry 1 (TGA/DSC 1) instrument manufactured by Mettler-Toledo.

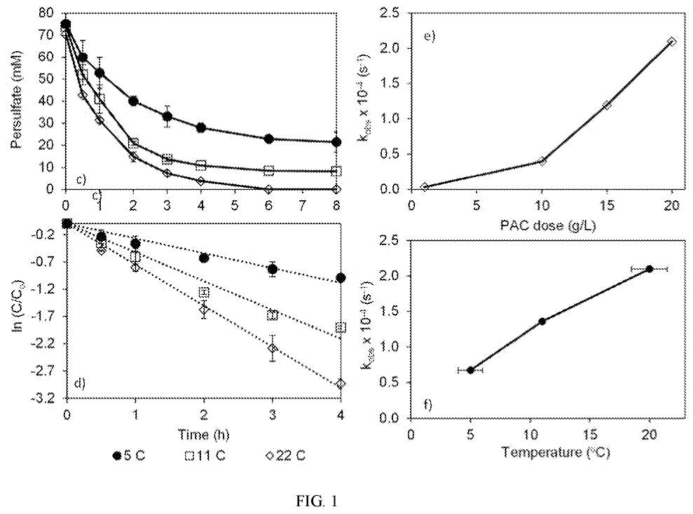

EXAMPLE. Persulfate activation by PAC. Persulfate activation at ambient temperature in ultrapure water at doses of 1, 10, 15, and 20 g/L PAC was achieved at ambient (22° C.) and low (5° C. and 11° C.) ambient environmental temperatures. Batch studies with 20 g/L PAC and 75 mM persulfate are shown in the following FIG. 1. The observed exponential decrease of the persulfate concentration suggested first order kinetics in persulfate disappearance, which enabled the calculation of the rate constants for the reaction

$$ln ( \frac{C}{{C}_{0}} ) = {k}_{obs} * t$$

where, C is the persulfate concentration at a specific time, t, Cₒ is the initial persulfate concentration, and k_{obs} is the first-order reaction rate constant. The persulfate half-life ranges from 0.92 to 63.8 hours across the PAC concentration range, and pH rapidly decreases and remains acidic under the conditions tested.

Persulfate activation is achieved at low temperature, including 5° C. and 11° C., demonstrating that the remediation processes and systems described herein are useful in situ in locations or during seasons where temperatures are colder.

EXAMPLE. Ambient temperature reactivity studies. Batch reactor experiments are carried out in triplicate in 1 L amber high-density polyethylene (HDPE) bottles at ambient temperature (22±3C). Low temperature experiments (5-11° C.) are performed either in an ice bath or refrigerator. The temperature is periodically monitored to ensure that it remains within 2° C. Solutions for the batch experiments contain the following: (1) ultrapure water (in all cases), (2) PFOA, PFHpA, PFHxA, PFPeA, and PFBA, (3) 1,4-dioxane, and (4) PFOA and 1,4-dioxane. Solutions containing 1, 10, 15 and 20 g/L PAC are prepared in ultrapure water and mixed on a shaker for at least 72 h prior to the addition of potassium persulfate. For experiments with 1,4-dioxane and PFOA, controls without PAC are used to monitor losses to volatilization. Potassium persulfate stock solutions are prepared 30 minutes prior to addition to the reaction mixture. Reactions are initiated by spiking each amber HDPE jar with the potassium persulfate stock solutions to a final persulfate concentration of 75 mM. Experiments are carried out for a duration of 6 to 12 h and 10 mL aliquots of the reaction mixture are collected at various time points. Samples are pipetted into 15 mL centrifuge tubes containing 500 μL methanol to quench radical species with PFCAs and 1,4-dioxane. Aliquots are immediately subjected to persulfate concentration analysis (10 μL aliquots are added to 5 mL potassium iodide) and pH measurement. See also Liang et al., A rapid spectrophotometric determination of persulfate anion in ISCO. Chemosphere 73(9): 1540-1543 (2008). pH is measured using a Mettler Toledo™ S220 SevenCompact™ pH/ion bench-top meter (Columbus, Ohio 43240). Aliquots (1 mL) of each solution mixture are used for fluoride measurements (1 mL aliquots are diluted in 1 mL of TISAB buffer and fluoride ion concentration is measured using a fluoride selective probe. See also Martínez-Mier et al., Development of Gold Standard Ion-Selective Electrode-Based Methods for Fluoride Analysis. Caries Research 45(1): 3-12 (2011); Tusl, Fluoride ion activity electrode as a suitable means for exact direct determination of urinary fluoride. Analytical Chemistry 44(9):1693-1694 (1972). Tubes are stored in a refrigerator at 20° C. until use, at which time the mixture is centrifuged at 5,000 rpm for 10 minutes prior to analysis. For 1,4-dioxane measurements, 3 to 5 mL of the supernatant is added to a GC-headspace vial containing 400 μL of methanol and 2 g of sodium chloride. For PFCA measurement, 1 mL of the supernatant is pipetted into a 2 mL centrifuge tube containing 100 μL isotopically-labeled PFOA, PFHxA, PFHpA, PFPeA, and PFBA standards in methanol and extracted using a liquid-liquid extraction with methyl tert-butyl ether. See also Liu et al., Optimization of extraction methods for the analysis of PFOA and PFOS in the salty matrices during the wastewater treatment. Microchemical Journal 155:104673 (2020). Standard error of the data is represented in the figures using error bars and is calculated by dividing the standard deviation by the square root of the number of observations.

EXAMPLE. Analysis of spent PAC. Spent PAC is recovered after reacting 15 g of PAC with 75 mM potassium persulfate for 24 hours using vacuum filtration with Grade 42 Whatman filter paper on a Buchner funnel, followed by heating to 950° C. in an inert gas. The spent PAC and fresh PAC are characterized and compared.

Using TGA, the spent PAC sample displayed large losses in mass as temperature is increased from 220° C. and 600° C. in comparison to the fresh PAC sample, which did not undergo any loss of mass. Persulfate and oxygen-derived functional groups are removed in the form of SO₂ and CO/CO₂ upon heating the spent PAC sample.

N₂ adsorption isotherms at 77 K were used to calculate BET surface areas. Fresh PAC was as high as 915 m²/g, whereas spent PAC had a specific surface area of 398 m²/g, a substantial 58% reduction. Pore size distribution (PSD) confirms the surface area loss in the spent PAC. The pore space lost was primarily micropores with pore sizes smaller than 2 nm. Micropore volume calculated from raw N₂ isotherm using the Dubinin-Radushkevich (DR) equation decreased from 0.342 cm³/g in fresh PAC to 0.149 cm³/g in spent PAC. Heat treatment to 950° C. showed partial recovery of the surface area and porosity. Without being bound by theory, it is believed herein that that oxygen-derived functional groups and persulfate moieties are released from the PAC surface as gaseous carbon, which alters the microporosity.

FTIR spectra displayed signals at 1160 cm⁻¹ and 1715 cm⁻¹ in spent PAC indicative of oxygen-derived functional groups, epoxide (C—O) and carboxyl or carbonyl (C═O) groups, respectively. Fresh PAC shows only an adjacent peak at 1585 cm⁻¹ generally attributed to the vibration frequency of a pristine graphenic domain (C═C). X-ray photoelectron spectroscopy (XPS) analysis showed weak potassium binding energies ˜2.9 atom % of sulfur, indicating the presence of potassium and persulfate in the spent PAC, and a high level of oxidation with a C:O ratio of 4.3:1. Fresh PAC showed a C:O ratio of 18.1:1. Without being bound by theory, it is believed herein that persulfate forms a stable covalent bond with carbon atoms in PAC resulting in severe oxidation of the PAC surface. Further, without being bound by theory, it is believed herein that the primary mechanism for organic contaminant degradation using PAC and persulfate does not arise from surface peroxide (—OOH) groups because of the absence of oxygen-derived functional groups on the PAC surface before the reaction, nor from the resulting formation of oxy and peroxy radicals.

EXAMPLE. EPR spectroscopy. Ambient temperature X-band (9.8 GHz) EPR spectroscopy measurements are performed on an EMX-plus continuous-wave (CW) spectrometer (Bruker Biospin Corporation). DMPO is used as the spin-trapping reagent to probe the radical species in the reaction mixture containing persulfate and PAC. Excess DMPO (140 mM) or TEMP (100 mM) is incubated with 15 g/L PAC in ultrapure water for at least 24 hours to account for any effective adsorption. EPR spectra of DMPO and PAC are acquired as a control experiment. To initiate the reactions, potassium persulfate (75 mM) is added to the PAC/DMPO solution, and the mixture is transferred to 50 μL glass capillary tubes. Two control experiments are performed. The first control contains 15 g/L PAC mixed with DMPO or TEMP and not spiked with persulfate. The second control only contains DMPO or TEMP (no PAC) and is spiked with persulfate. EPR spectrum of each capillary sample are acquired (9.875 GHz microwave frequency, 30 dB receiver gain, 100 kHz modulation frequency, 0.5 G modulation amplitude and 5 mW microwave power). Typically, 10 scans are averaged for each spectrum. The instrumental parameters are kept constant, and the peak height of the radical is used to trace relative intensity over 90 minutes after initiating the reaction.

EPR spectral simulations of DMPO adducts were performed using EasySpin 5.2.33 in conjunction with MATLAB R2021a, using the garlic sub-routine for the simulation of isotropic and fast motion CW EPR spectra. The values for the g-tensor, isotropic hyperfine coupling constants of the ¹⁴N and ¹H atoms, A_{N} and A_{H}, respectively, Gaussian and Lorentzian line widths, and the rotation correlation time were treated as variables. The experimental EPR spectrum was found to be comprised of two separate radical species that contributed to the quartet and triplet spectral components. The radical species were treated as separate spin systems in the simulations and the values of each system were varied reiteratively to best match the experimental spectrum. A single component fit adequately accounts for the quartet and triplet signals observed in the experimental EPR spectrum and corresponds to the oxidation of DMPO to DMPOX.

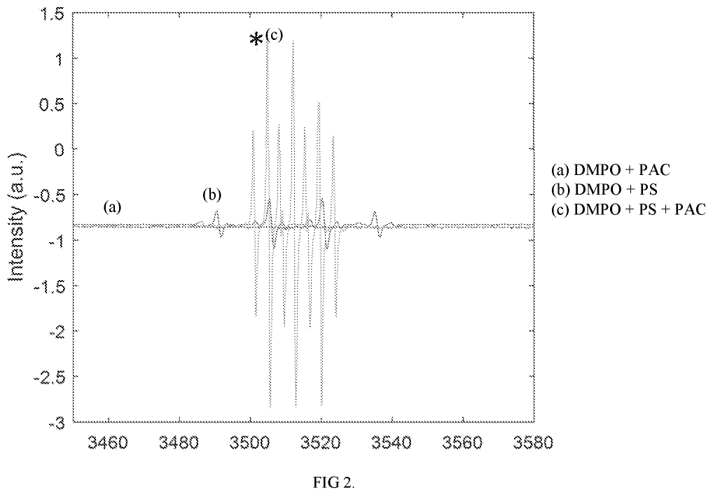

Prior EPR studies using alternative activation methods have failed to detect DMPOX. It has been discovered herein that the type and relative concentrations of various ROS depends upon the method of activation. When PAC was mixed with DMPO and spiked with persulfate, a different, very strong EPR spectrum was observed, as sown in FIG. 2.

The EPR does not match the spectra for radicals typical of a persulfate reaction, such as hydroxyl or sulfate (DMPO-OH or DMPO-SO₄), with other activation methods, indicating that sulfate or hydroxyl radicals are not the primary ROS during persulfate activation using PAC at ambient temperature. Instead, and a stronger oxidative species is rapidly formed (<30 seconds). Without being bound by theory, it is believed herein that the stronger oxidative species is a peroxyl radical formed by direct electron transfer.

EXAMPLE. Non-targeted analysis for transformation products. Non-targeted liquid chromatography-high resolution mass spectrometry (LC-HRMS) analysis is performed to identify transformation products using a Thermo Q Exactive HF-X Orbitrap LC-HRMS system. Samples are injected with a 10 μL injection volume. Sample components are separated on a Thermo Hypersil Gold Vanquish C18 column (50 mm×2.1 mm×1.9 μm) at a constant temperature of 60° C. Spectral libraries, including Thermo mzCloud, and ChemSpider, along with mass lists containing 8,142 fluorinated compounds from the EPA's ToxCast/CompTox database are used for identification. Confidence scores of the features detected were assigned based on the Schymanski Scale.

EXAMPLE. Application of the PAC/persulfate system to degrade PFOA and 1,4-dioxane. Batch studies were performed PFOA, 1,4-dioxane, and mixtures thereof, at ambient temperature. Control experiments were performed to account for volatile losses. Adsorption equilibria were assessed for both PFOA and 1,4-dioxane individually over 96 hours. 1,4-dioxane reached adsorption equilibrium with 24 hours of mixing. PFOA adsorption equilibrium was reached within 48 hours.

Prior to adding persulfate to initiate the oxidation reaction, PFAS and/or 1,4-dioxane were mixed with PAC for a minimum of 72 h to allow sorption to occur. While PFAS and 1,4-dioxane are common co-contaminants in the environment, these two chemicals differ markedly in adsorption capacity to carbon. The PFAS salts included PFOA and PFHpA, PFHxA, PFPeA, and PFBA impurities at measurable levels. PFOA exhibited the highest adsorption capacity for PAC (316 μg/g PAC), and the capacity decreased with decreased carboxylic acid chain length. 1,4-dioxane adsorbed to PAC (55.9 μg/g PAC) only weakly in comparison to PFOA.

In experiments with only 1,4-dioxane, the solutions were mixed for 72 hours with PAC and then spiked with persulfate (75 mM). Prior to PAC adsorption, the 1,4-dioxane concentration was 13,050 nM. 1,4-dioxane concentration after adsorption, prior to adding persulfate, was 340 nM. 1,4-dioxane concentration decreased over the course of 6 hours and was less than the LOD within 3 h of the persulfate addition. As expected, both the pH and persulfate concentration decreased over the course of the reaction, from 7.5 to 1.08 and 75 mM to 5 mM, respectively.

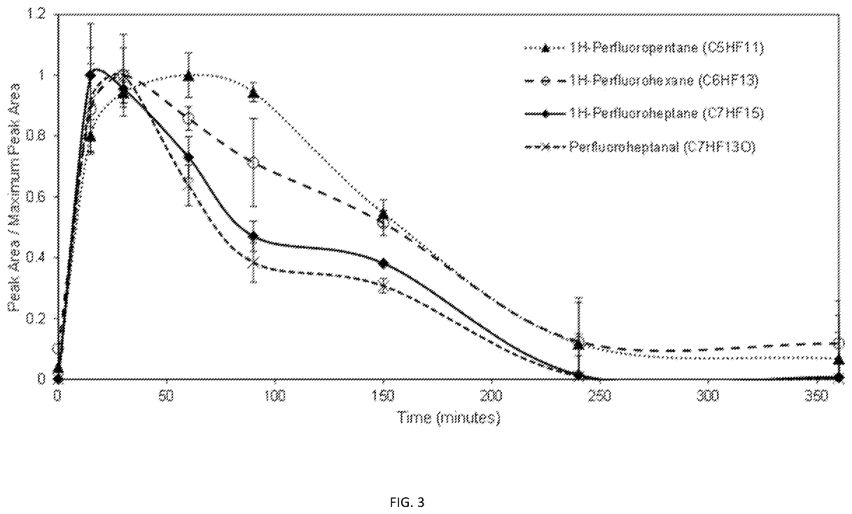

In experiments with PFOA and shorter PFCAs, after at least 72 hours of mixing to allow for PFAS adsorption, persulfate was added to the solution. Prior to adsorption, the concentrations of PFCAs were 0.0688 μM PFBA, 0.222 μM PFPeA, 3.92 μM PFHxA, 12.8 μM PFHpA, and 67.1 μM PFOA (Table S3). The concentrations after adsorption, prior to spiking with persulfate, were 8.80×10⁻³ μM PFBA, 2.06×10⁻² μM PFPeA, 0.219 μM PFHxA, 0.128 μM PFHpA, and 25.9 μM PFOA. The persulfate concentration and pH decreased over 6 h. Figure S12a shows the change in PFOA, PFHxA, PFHpA, PFPeA, and PFBA concentration after persulfate was added at ambient temperature. Following persulfate addition, the PFOA decomposed rapidly, and was 97% removed within 6 hours. Similarly, the concentration of PFHxA and PFHpA also decreased 72% and 76%, respectively. As expected, the concentration of the shorter chain length PFCAs, PFBA and PFPeA, much of which are byproducts of longer chain decomposition, increased over the course of the 6-h reaction, as did the concentration of fluoride ions. Using non-targeted LC-HRMS analysis, additional byproducts 1H-perfluoroheptane, perfluoroheptanal, 1H-perfluorohexane, and 1H-perfluoropentane were detected. 1H-perfluoroheptane reached its maximum peak area at 15 minutes, while 1H-perfluorohexane and perfluoroheptanal peaked at 30 minutes and 1H-perfluoroheptane peaked at 60 minutes, indicating their order of formation. The peak area counts for each transformation byproduct is plotted and shown in FIG. 3.

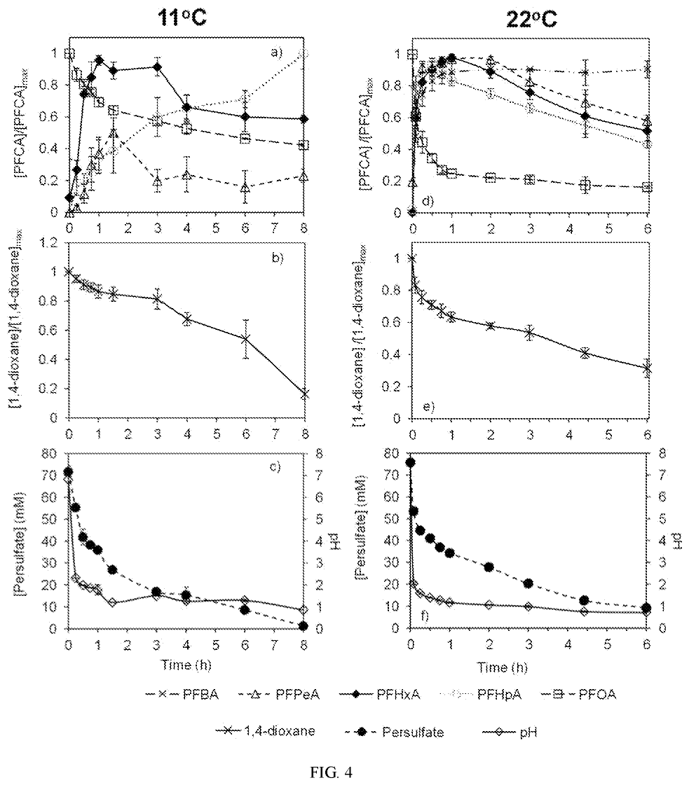

Experiments with both PFOA and 1,4-dioxane present as co-contaminants in the initial solution were carried out at 11° C. and ambient temperature (22° C.). Control experiments without PAC were performed to monitor volatile losses. Adsorption equilibrium was established with PAC for 96 h at ambient temperature in triplicate. 1,4-dioxane adsorption stabilized within 24 hours, while PFOA adsorption stabilized after 48 hours. In these adsorption experiments, the concentration of smaller chain PFCAs after adsorption was less than the LOD. Compared to experiments with only PFOA or 1,4-dioxane, in the competitive adsorption experiments, 1,4-dioxane adsorption was 77.8% less (43.5 μg/g PAC) and PFOA adsorption was 78.3% less (316 μg/g PAC). The solutions were mixed for 72 hours prior to spiking with persulfate to allow adsorption to occur. Prior to adsorption, the PFOA concentration was 6890 nM and the 1,4-dioxane concentration was 15,220 nM at ambient temperature. Following adsorption, the concentration of PFOA was 40 nM and 1,4-dioxane concentration was 450 nM. Short chain PFCAs were detected in the initial solutions in low concentrations due to impurities in the PFOA (PFBA=<LOD, PFPeA=0.055 nM, PFHxA=0.033 nM, and PFHpA=0.035 nM). At 11° C., after adsorption for 72 hours, the initial concentrations were 2,240 nM PFOA and 1.38 nM PFHxA (PFBA, PFPeA, and PFHpA were <LOD). After 72 h of mixing, the solutions were spiked with persulfate (75 mM, ambient temperature). The 11° C. experiment was carried out for 8 hours while the ambient temperature experiment was carried out for 6 hours. PFOA and 1,4-dioxane concentrations decreased at 11° C. and at ambient temperature. Results are shown in FIG. 4.

As PFOA degraded, shorter chain length carboxylic acids were formed at both temperatures, as indicated by an increase in their concentrations. Initially PFHpA appeared in the ambient temperature experiment, followed by the formation of PFHxA, PFPeA, and finally PFBA. The same pattern was observed at 11° C.; however, PFBA was <LOD throughout the experiment. The fluoride ion concentration was less than the limit of detection throughout the entire experiment due to the lower initial PFOA concentration used in these experiments.

Without being bound by theory, it is believed herein that electron transfer is a primary mechanism for PFAS defluorination. The absence or low concentration of hydroxyl radical species under PAC activation, and the stepwise formation of C4-C7 PFCAs suggests that PFOA degradation initially occurs via Kolbe decarboxylation through electron transfer via the persulfate and PAC to form 1H-perfluoroheptane. 1H-perfluoroheptane subsequently degrades via peroxyl radicals to form perfluoroheptanal, which is oxidized to form PFHpA. Based on the detection of 1H-perfluorohexane and 1H-perfluoropentane, it is believed herein that the cycle is repeated to form shorter chain PFCAs.

SYSTEM EXAMPLE. It is appreciated that laboratory scale tests are useful in designing and/or optimizing larger scale systems for on-site or field environmental remediation.

Laboratory tests can be conducted in batch tests, such as in a beaker, or in continuous tests, such as column tests using conventional chromatography equipment.

Initial laboratory tests may be first performed with uncontaminated or artificial media (i.e., water amended to be chemically like groundwater, or uncontaminated clean quartz sand) to evaluate initial chemical kinetics and reactions. For example, initial tests to determine what pH may be generated from dissolution of the persulfate in the first stage, ability of different types of iron catalysts to activate the persulfate, etc. may be evaluated and/or optimized

Contaminated groundwater and soil are retrieved from the field site and used for the experiments. It is appreciated that the contaminated soil and/or groundwater can be modified to increase contaminant concentrations to evaluate a wider range of conditions.

The contaminated soil, or other artificial or uncontaminated media, and treatment reagents are loaded into a soil column, which is commonly constructed from a section of pipe made from material that is resistant to the chemicals and reaction conditions; or alternatively a material that is transparent to allow visual observation of potential changes in color or other characteristics that may reflect the reactions or the indicate a problem such as gas formation that may plug water flow through the column.

Water is pumped into the column from the bottom and allowed to exit from the column at the top to allow uniform water flow through the soil in the column (or minimize the likelihood of “channeling” or preferred pathways). It is to be understood that alternative configurations are possible.

Water is generally pumped into the column so that the rate of water flow through the column is similar to the rate at which water is flowing in the aquifer (the rate in the aquifer is developed as part of the conceptual site model).

The effluent that is exiting from the top of the column is sampled to evaluate contaminant transformation and/or changes in geochemical conditions relevant to the influent being pumped into the column. These data can be used to demonstrate treatment effectiveness, and to inform changes to improve treatment effectiveness and/or to help determine field reagent requirements.

The effluent from one column can also then be pumped into one or more subsequent columns to simulate the effects of different treatment zones or stages. For example, the first column may have the oxidant, and a second column may have the buffer and/or the carbon.

Batch configurations of the invention described herein are capable of degrading/removing 98% of PFAS, such as PFOA, within 6 hours. Batch configurations of the invention described herein are capable of degrading/removing ˜100% of 1,4-dioxane as a co-contaminant within 6 hours.

Column configurations of the invention described herein are capable of decreasing all PFAS to <20 ppt, and in some cases, to nondetectable levels, with a 9.2 h residence time. Column configurations of the invention described herein are capable of decreasing 1,4-dioxane as a co-contaminant to <3 ppb with a 9.2 h residence time.

Column configurations of the invention described herein that include a buffer in stage 2 are capable of decreasing all PFAS to <20 ppt, and in some cases, to nondetectable levels, with a 2.5 h residence time. Column configurations of the invention described herein are capable of decreasing 1,4-dioxane as a co-contaminant to <3 ppb with a 2.5 h residence time.

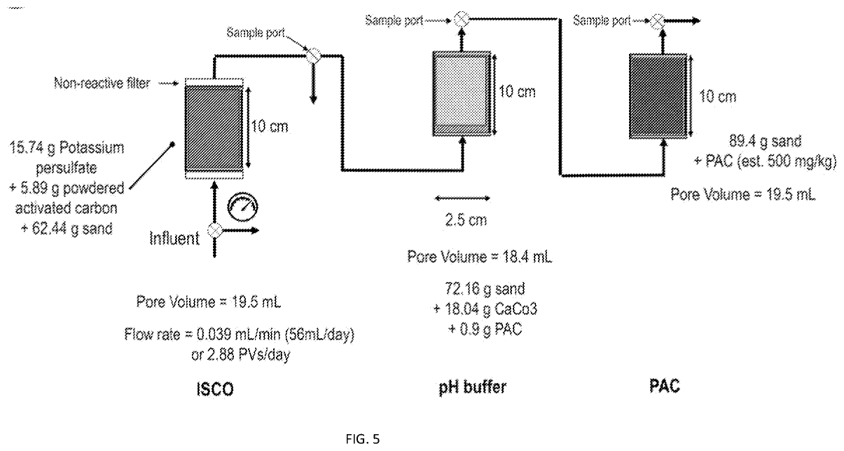

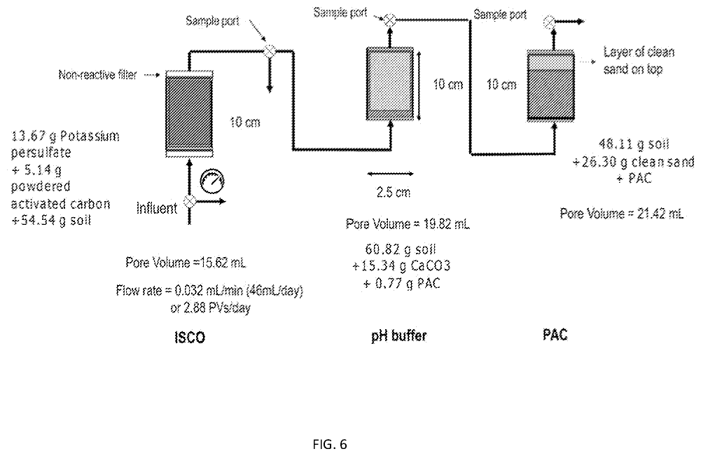

Illustrative set-ups are shown in FIG. 5 and FIG. 6.

SYSTEM EXAMPLE. Field scale. At a contaminated site, a detailed conceptual site model (CSM) is first developed in order to understand what contaminants are present and their concentration, at what depth(s) the contaminants are found, and the hydrogeologic conditions at the site such as what depth(s) groundwater is found, what direction(s) groundwater is moving, what rate(s) groundwater is moving at, and the geochemical conditions (such as pH, temperature, and oxidation-reduction potential of the groundwater, and concentration(s) of metals and other compounds that may not be considered contaminants but that may affect the treatment conditions.

Utilizing the CSM, the vertical intervals requiring treatment, and location of where the reagents can be delivered, and the amount(s) of each reagent required are determined. These estimates rely particularly on the groundwater velocity and contaminant concentrations in each of the treatment intervals, and accessibility to construct the treatment stages.

The reagents can be delivered to the subsurface by several different methods. In one embodiment, the reagents are first blended with water and other amendments to form a slurry with a high solids content. This slurry is then injected by a process commonly referred to as hydrofracturing. A boring is advanced into the ground to access the subterranean formation and the reagents are injected under pressure into the formation. Each boring may have one or more injection intervals at different vertical depths. A monitoring well or a vertical pipe installed in the ground can similarly be used to inject the reagents. Typically, there is a plurality of injection borings or wells that are oriented perpendicular to the general direction of groundwater flow, so that groundwater must flow through the emplaced reagents and thus be treated, in both horizontal and vertical directions. The spacing between the borings or between the trenches is determined based upon the CSM.

For example, the processes and systems described herein may be performed or operated by injecting or installing reagents into the subsurface to create one or more permeable reactive barriers (PRBs) or permeable reactive treatment zones, through which groundwater will flow and be treated by the reagents. The first PRB zone is comprised of the oxidative reagent. A second PRB zone is comprised of an adsorbing reagent. A pH buffer may be blended with the adsorbing reagent, or alternatively injected or installed into the subsurface at a point between the first PRB and second PRB.

In an alternative embodiment, the processes and systems described herein may be performed or operated where the PRBs can be created by excavating a trench, and the reagents added into the trench. Similarly, the trench is often oriented perpendicular to the general direction of groundwater flow. The bottom of such a trench is often extended into a low-permeability zone to prevent groundwater requiring treatment from flowing under it, and the trench is often extended at the horizontal margins to ensure groundwater requiring treatment does not flow around the trench.

In another alternative embodiment, the processes and systems described herein may be performed or operated in a funnel and gate configuration, where sheet piling, one or more slurry walls, alternative types of an impermeable wall, or a combination thereof is constructed. Typically, the funnel and gate configuration includes at least two sides shaped like the cross section of a funnel to direct groundwater into a smaller area for treatment, also referred to as a gate. It is appreciated herein that inside the gate area, the system can be constructed or operated to allow the various reagents to be placed in sequence, and when necessary, more easily replaced or supplemented during operation of the process and system.

Groundwater upgradient, cross gradient, and downgradient is monitored (for example, via periodic collection of groundwater samples from monitoring wells installed in and adjacent to the treatment stages) in order to ensure the remedy is performing as designed. The groundwater can be analyzed for the contaminant concentrations, and for geochemical changes associated with the reagents (for example, pH and oxidation-reduction potential) to ensure and demonstrate that treatment is occurring.

The treatment reagents have a finite lifetime in the subsurface. For example, the potassium persulfate reagent and the calcium carbonate reagent will slowly dissolve over time, and the sorption sites on the carbon can become saturated and no longer sorb contaminants. This is evaluated by the groundwater monitoring. As this occurs, additional reagents can be added as needed to maintain effective treatment conditions.

SYSTEM EXAMPLE. Initial batch studies with PAC and persulfate in deionized water, demonstrated that increasing the PAC dose led to higher persulfate activation rates. Characterization of the spent PAC using BET surface area before and after reaction demonstrated a large reduction in surface area (915 m²/g prior to reaction to 398 m²/g after the reaction), indicating that persulfate blocks within the micro- and mesopores of the PAC. The PAC/persulfate system was used to study the kinetics of 1,4-dioxane and PFOA oxidation in batch studies at ambient conditions. 1,4-dioxane was completely oxidized and PFOA was converted to smaller perfluorinated carboxylic acids within 6 hours at ambient temperature with PAC and persulfate.

SYSTEM EXAMPLE. The PAC/persulfate system is adapted to assess a field set-up using a continuous flow system using columns of sand and contaminated soil and flowing groundwater. Persulfate efficiently removes both 1,4-dioxane and PFOA. 1,4-dioxane and PFOA removal continues even after the persulfate is consumed, indicating the PAC also adsorbs residual co-contaminants.

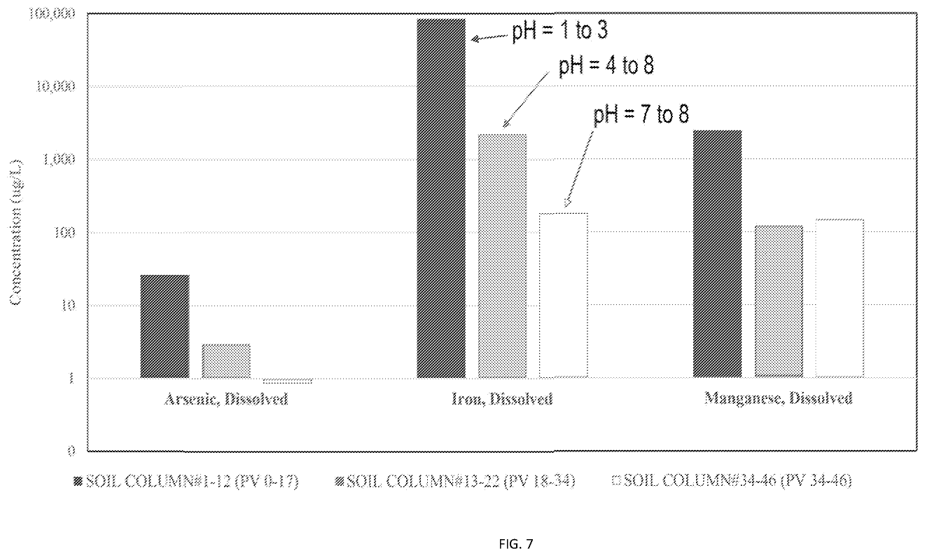

SYSTEM EXAMPLE. Metals immobilization during first stage with buffering is shown in FIG. 7. The feed solution was sample groundwater; and the column was loaded with 100 g of sample soil mixed with 1 g PAC and 20 g potassium persulfate.

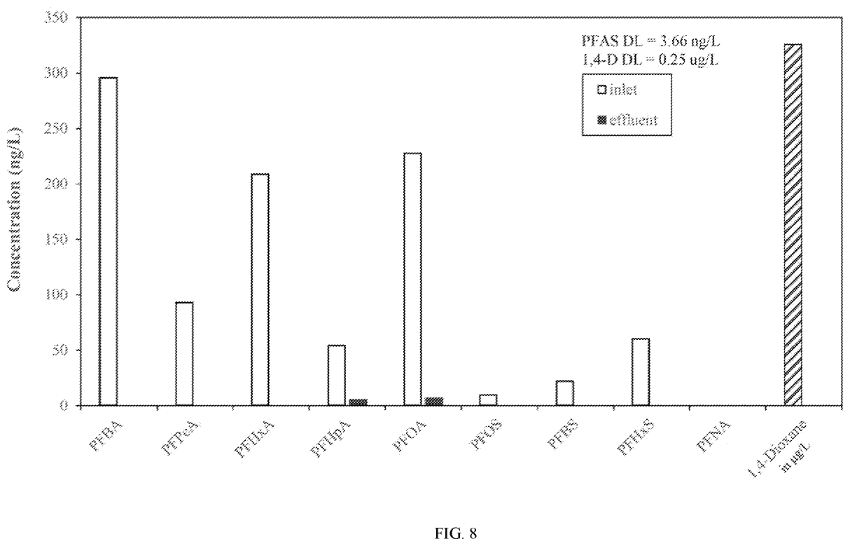

SYSTEM EXAMPLE. Treatment of sample groundwater having various contaminants, using sample ground water as the eluent. After 35 pore volumes, all contaminants except for PFHpA and PFOA were not detectable, as shown in FIG. 8.

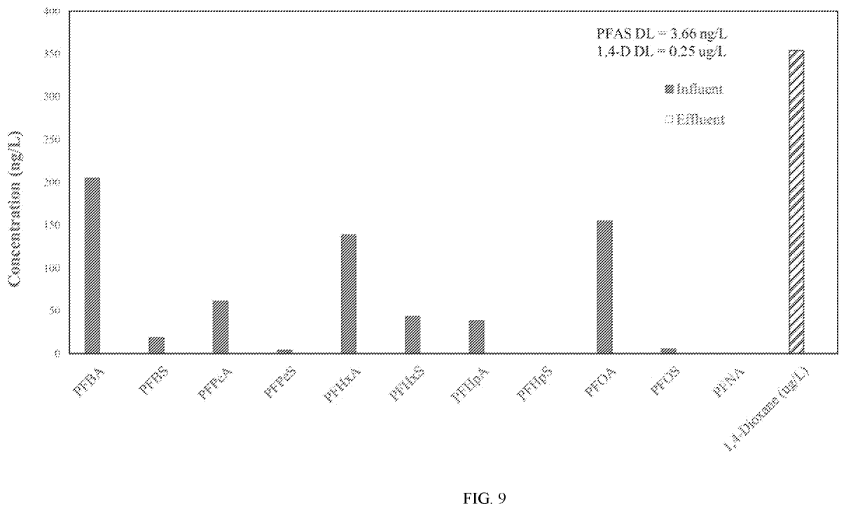

SYSTEM EXAMPLE. Treatment of a mixture of sample groundwater and contaminated soil having various contaminants, using site ground water as the eluent. After 25 pore volumes, all contaminants were not detectable, as shown in FIG. 9.

EXAMPLE. Spectral simulations indicated that the ROS converted spin trapping agent 5,5-Dimethyl-1-pyrroline N-oxide (DMPO) to 5,5-dimethylpyrrolidone-2(2)-oxyl-(1) (DMPOX), which is only formed in the presence of strong oxidizers, such as peroxyl radical species. The reactive species generated by persulfate (75 mM) activated with PAC (20 g/L) simultaneously degrades both PFOA and 1,4-dioxane at ambient temperature and low temperatures, including 11° C. Degradation of 80% of the PFOA and 70% of the 1,4-dioxane was accomplished in 6 h at ambient temperature. At 11° C., degradation of 54% of the PFOA and 57% of the dioxane was accomplished in 6 h.

1. A system for remediating a contaminant in the environment, the system comprising:
(a) a first stage adapted to decompose at least a portion of the contaminant, the first stage comprising a process comprising (1) providing an oxidant comprising one or more persulfate salts, or one or more peroxide salts, or any combination thereof; (2) activating the oxidant with an activating agent; and (3) contacting the contaminant with the activated oxidant whereby at least a portion of the contaminant is decomposed;
(b) a two-part second stage adapted to adsorb at least a portion of the contaminant, the second stage comprising a process comprising contacting the contaminant with (1) a buffering compound adapted to increase the pH of at least a portion of the environment containing the contaminant; and (2) an adsorbent comprising activated carbon, whereby at least a portion of the contaminant is absorbed or adsorbed;
wherein the first stage is separated from the second stage; and
wherein the buffering compound is included in a third stage between the first and second stages, or optionally combined with the adsorbent in the second stage.

2. A composition configured for remediating an organic contaminant in the environment/groundwater, the composition comprising a persulfate salt and one or more activating agents.

3. The composition of claim 2 wherein the persulfate salt is potassium persulfate, sodium persulfate, or a combination thereof.

4. The composition of claim 2 wherein the persulfate salt is potassium persulfate.

5. The composition of claim 2 wherein the activating agent is a transition metal cation or PAC, or a combination thereof.

6. The composition of claim 2 wherein the activating agent is an iron sulfide.

7. The composition of claim 2 wherein the combined amount of the one or more activating agents is sufficient to produce hydroxyl radicals, sulfate radicals, other reactive oxygen species, and combinations thereof, in-situ.

8. The composition of claim 2 wherein the organic contaminant includes one or more polyfluoroalkyl substances (PFAS).

9. The composition of claim 8 wherein the PFAS include one or more perfluoroalkyl substances.

10. The composition of claim 8 wherein the PFAS include one or more polyfluorocarboxylates, one or more polyfluorosulfonates, or a combination thereof.

11. The composition of claim 8 wherein the PFAS include one or more perfluorocarboxylates, one or more perfluorosulfonates, or a combination thereof.

12. The composition of claim 8 wherein the PFAS include perfluorooctanoic acid (PFOA), perfluorooctanesulfonic acid (PFOS), or a combination thereof.

13. A process for remediating an organic contaminant in the environment/groundwater, the process comprising (a) introducing the composition of claim 2 into a reactive treatment zone containing soil or water, or both.

14. The process of claim 13 further comprising (b) introducing activated carbon into the reactive treatment zone, where the activated carbon is configured to adsorb one or more PFAS.

15.-16. (canceled)

17. The process of claim 13 wherein step (a) includes a composition configured to remediate cVOCs, petroleum hydrocarbons, 1,4-dioxane, PFCAs, or a combination thereof.

18. The process of claim 13 wherein the process is configured for treating ground water in situ.

19. The process of claim 13 wherein the treatment zone is an aquifer.

20. The process of claim 13 an wherein the process is configured for treating water ex-situ.

21. A kit comprising a predetermined quantity of the composition of claim 2; and instructions for co-introduction of the kit components into a reactive treatment zone containing soil or water, or both.

22. A packaged article comprising a predetermined quantity of the composition of claim 2; and instructions for co-introduction of the kit components into a reactive treatment zone containing soil or water, or both.
